(19) United States
(12) Patent Application Publication
(10) Pub. No.: US 2014/0253444 A1
(43) Pub. Date: Sep. 11, 2014

(54) MOBILE COMMUNICATION DEVICES AND MAN-MACHINE INTERFACE (MMI) OPERATION METHODS THEREOF

(71) Applicant: INDUSTRIAL TECHNOLOGY RESEARCH INSTITUTE, HSINCHU (TW)

(72) Inventors: Yong-Hua Cheng, Kaohsiung City (TW); Han-Chiang Chen, Tainan City (TW); Yi-Hung Lu, Kaohsiung County (TW); Hsiao-Hui Lee, Tainan City (TW); Chin-Chen Lee, Tainan City (TW)

(73) Assignee: INDUSTRIAL TECHNOLOGY RESEARCH INSTITUTE, HSINCHU (TW)

(21) Appl. No.: 14/032,037

(22) Filed: Sep. 19, 2013

(30) Foreign Application Priority Data
Mar. 6, 2013 (TW) 102107807

(51) Int. Cl. G06F 3/041; G06F 3/0486

(52) U.S. Cl. CPC G06F 3/0416; G06F 3/0486
USPC 345/158

(57) ABSTRACT

A mobile communication device including a wireless communication module, a local display device, and a processing module is provided. The wireless communication module performs wireless transceiving to and from a display host machine. The local display device is equipped with a first display screen including a first control area and a second control area within the first control area. The processing module detects a first touch event in the first control area and a second touch event for moving the second control area within the first control area, transforms coordinate information of the first and second touch events into a first set and a second set of coordinates on a second display screen of the display host machine, respectively, and presents a touch operation and a cursor operation on the second display screen via the wireless communication module according the first set and second set of coordinates, respectively.

### CROSS REFERENCE TO RELATED APPLICATION

This application claims priority of Taiwan Patent Application No. 102107807, filed on Mar. 6, 2013, the entirety of which is incorporated by reference herein.

### TECHNICAL FIELD

The disclosure generally relates to operation of a Man-Machine Interface (MMI), and to a mobile communication device and an MMI operation method for remotely controlling the MMI on the display screen of a display host machine from the mobile communication device.

### BACKGROUND

With increasing demands for mobile entertainment, various mobile services such as entertainment applications, information applications, and control applications, etc., and various devices such as smart phones, panel PCs, Notebook PCs, and portable gaming devices, etc., have been developed. Meanwhile, the application range has expanded from the mobile market to the home environment. For example, entertainment equipment in an average home environment may generally include a game console, a video recorder/player, a television (e.g., a smart TV, a Liquid-Crystal Display (LCD) TV, a Plasma TV, or a Cathode Ray Tube (CRT) TV, etc), and a Set-Top Box (STB), etc. In addition, several schemes are available nowadays for applying mobile communication devices to the home environment, by incorporating mobile communication devices with household entertainment equipment, to provide more flexible and convenient services.

However, the integration of services and devices/equipment is insufficient. In the aspect of application functions, present STBs and smart TVs do not provide seamless support for rapidly increasing mobile applications, causing most home users to continue to use mobile communication devices, such as a smart phone or panel PC, for obtaining mobile services. In the aspect of MMI operations, current operation methods for mobile communication devices are not suitable for the household scenario where a large TV may be placed far from the seating area. For example, there may be some mobile games which may be played from a TV, or there may be applications or services available for sending music and video to be displayed on a TV from a smart phone, or outputting or presenting information on the TV from the smart phone via a STB, but the MMI operations between the smart phone and the TV is relatively rough, and it is hard for users to fully or accurately control the MMI on the TV from the smart phone. Not to mention that conventional remote controls or additional devices or equipment are usually required to make up for deficiencies in the MMI operations.

### SUMMARY

In order to solve the aforementioned problem, the disclosure proposes a mobile communication device and an MMI operation method for integrating the MMI operations between the mobile communication device and a display host machine, by remotely controlling the MMI on the display screen of the display host machine from the mobile communication device.

In one aspect of the disclosure, a mobile communication device is provided. The mobile communication device comprises a wireless communication module, a local display device, and a processing module. The wireless communication module is configured to perform wireless transmission and reception to and from a display host machine. The local display device is equipped with a first display screen comprising a first control area and a second control area within the first control area. The processing module is configured to detect a first touch event inputted by a user in the first control area and a second touch event inputted by the user for moving the second control area within the first control area, and transform coordinate information of the first touch event and the second touch event into a first set of coordinates and a second set of coordinates on a second display screen of the display host machine, respectively. Also, the processing module is further configured to present a touch operation on the second display screen via the wireless communication module according the first set of coordinates, and present a cursor operation on the second display screen via the wireless communication module according the second set of coordinates.

In another aspect of the disclosure, an MMI operation method for a mobile communication device to remotely control a display host machine which is equipped with a first display screen comprising a first control area and a second control area within the first control area is provided. The MMI operation method comprises the steps of: detecting a first touch event inputted by a user in the first control area and a second touch event inputted by the user for moving the second control area within the first control area; transforming coordinate information of the first touch event and the second touch event into a first set of coordinates and a second set of coordinates on a second display screen of the display host machine, respectively; presenting a touch operation on the second display screen according the first set of coordinates; and presenting a cursor operation on the second display screen according the second set of coordinates.

Other aspects and features of the disclosure will become apparent to those with ordinary skill in the art upon review of the following descriptions of specific embodiments of the mobile communication devices and MMI operation methods.

### BRIEF DESCRIPTION OF DRAWINGS

The disclosure can be more fully understood by reading the subsequent detailed description and examples with references made to the accompanying drawings, wherein:

FIG. 1 is a block diagram illustrating a remote control system for MMI operations according to an exemplary embodiment;

FIG. 2 is a block diagram illustrating the MMI operations according to an exemplary embodiment;

FIG. 3 is a block diagram illustrating the system architecture of the mobile communication device 10 according to an exemplary embodiment;

FIG. 4 is a flow chart illustrating the MMI operation method according to an exemplary embodiment;

FIGS. 5A and 5B show a flow chart illustrating the type determination of the second touch event according to an exemplary embodiment;

FIGS. 6A and 6B show schematic diagrams for the controls of a mobile game via a movable control area according to an exemplary embodiment; and

FIG. 7 is a schematic diagram for the controls of a mobile game via a stationary control area according to an exemplary embodiment.

### DETAILED DESCRIPTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

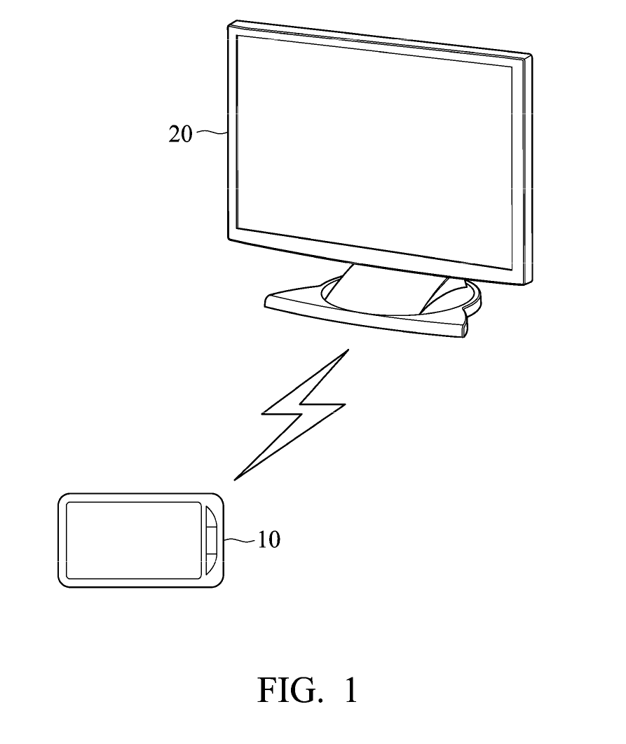

FIG. 1 is a block diagram illustrating a remote control system for MMI operations according to an exemplary embodiment. The remote control system for MMI operations includes a mobile communication device 10 and a display host machine 20, wherein the mobile communication device 10 may be a smart phone, panel PC, Notebook PC, or portable gaming device, etc., and the display host machine 20 may be a smart TV, or an LCD or Plasma TV incorporating an STB, etc. Both the mobile communication device 10 and the display host machine 20 support at least one common wireless technology for wireless transmission and reception therebetween. The mobile communication device 10 may transform the coordinate information of the touch event inputted thereon by a user into one or more sets of coordinates (i.e., the pair of x-coordinate and y-coordinate) on the display screen of the display host machine 20, and then transmit the transformed set(s) of coordinates to the display host machine 20 via the air interface to remotely present touch and cursor operations on the display screen of the display host machine 20.

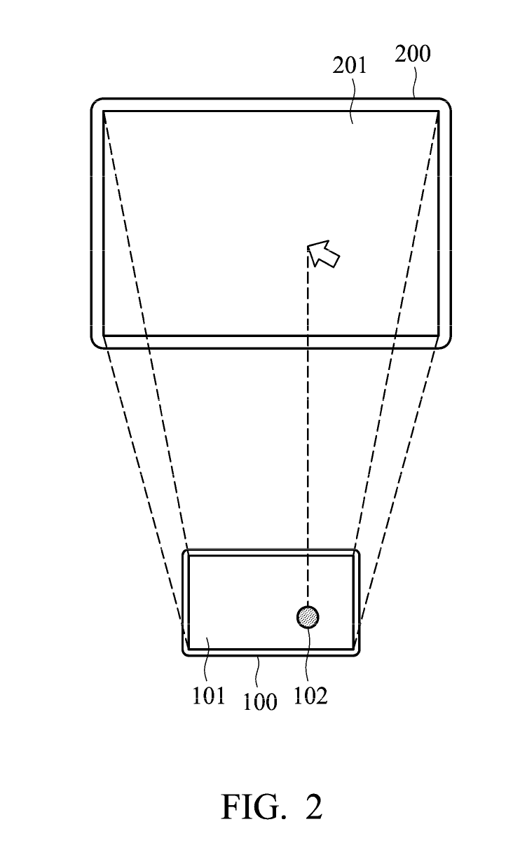

FIG. 2 is a block diagram illustrating the MMI operations according to an exemplary embodiment. The local display screen 100 and the remote display screen 200 represent the display screens equipped in the mobile communication device 10 and the display host machine 20, respectively. The display area 201 represents the entire display area of the remote display screen 200. The local display screen 100 includes two control areas 101 and 102, wherein the control area 101 represents the entire display area of the local display screen 100 and the control area 102 represents a movable control area. Particularly, the control area 102 is within the control area 101, and the control area 102 can be moved by the touch events inputted by the user. Namely, the local display screen 100 may be a touch screen for detecting touches and/or approximations of objects thereon. In this embodiment, the control areas 101 and 102 are denoted with different background patterns for identification purposes. Alternatively, the control areas 101 and 102 may be denoted with the same background pattern, and the user may identify one from the other by their respective margins. In another embodiment, the control area 101 may represent only part of the entire area of the local display screen 100.

To further clarify, the set of coordinates in the control area 101 of the local display screen 100 are mapped or transformed into the set of coordinates in the display area 201 of the remote display screen 200, wherein the coordinate mapping or transformation may be performed by enlarging the values of the set of coordinates in the control area 101 according to the ratio of the lengths, widths, or square measures of the control area 101 and the display area 201. In addition, after the coordinate mapping or transformation, the control area 102 is transformed into a particular set of coordinates in the display area 201 of the remote display screen 200, and a cursor is displayed in the particular set of coordinates. It is to be understood that the displayed cursor is not limited to the figure of an arrow as shown in FIG. 2, and the figure of another object may be used instead. Specifically, the center of the control area 102 may be used as the point for the coordinate mapping or transformation, or any point in the control area 102 may be used instead for the coordinate mapping or transformation.

In another embodiment, there may be more than one movable control area in the control area 101 of the local display screen 100, and the disclosure is not limited thereto. The number of movable control areas may vary depending on the requirement of the application in use.

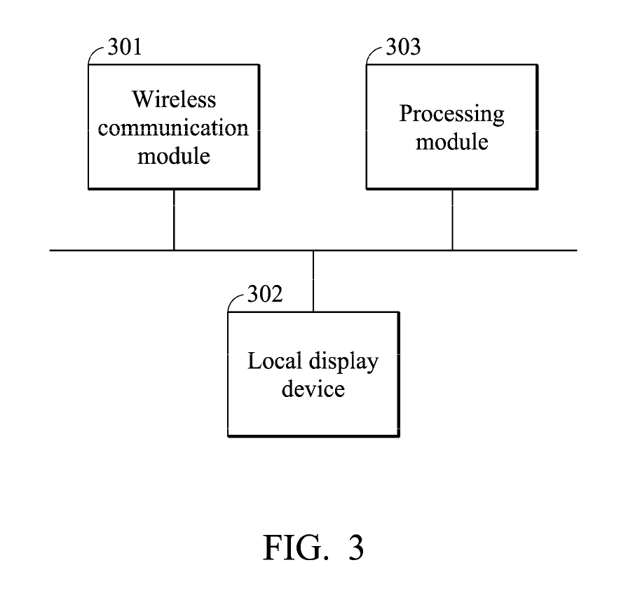

FIG. 3 is a block diagram illustrating the system architecture of the mobile communication device 10 according to an exemplary embodiment. The mobile communication device 10 includes a wireless communication module 301, a local display device 302, and a processing module 303. The wireless communication module 301 may be a communication module supporting any one of many wireless technologies, such as Bluetooth, WiFi, Near Field Communication (NFC), or ZigBee technology, etc., for providing the function of wireless transceiving. The local display device 302 may be a display device capable of sensing touches and/or approximations of objects thereon, such as a capacitive touch panel, a resistive touch panel, or an optical touch panel. The processing module 303 may be a general-purpose processor, an application processor, or a Micro Control Unit (MCU), for providing the function of data processing and computing, and for controlling the operations of the wireless communication module 301 and the local display device 302 to perform the MMI operation method.

Although not shown, the mobile communication device 10 may further include other functional units or modules, such as a storage module (e.g., volatile memory, non-volatile memory, hard disc, optical disc, or any combination of the above media), and an Input/Output (I/O) device (e.g., keyboard, mouse, or touch pad, etc.), and the disclosure is not limited thereto.

Similarly, the system architecture shown in FIG. 3 may also be applied to the display host machine 20. The detailed description of the system architecture of the display host machine 20 is omitted herein for brevity, as reference may be made to the embodiment of FIG. 3.

For example, if the operating system of the mobile communication device 10 is an Android system, software modules corresponding to the touch detection, the coordinate mapping or transformation, and the remote control by touch and cursor operations may be implemented using the open Application Programming Interface (API) of the Android system, and the software modules may be loaded, complied, and executed by the processing module 303.

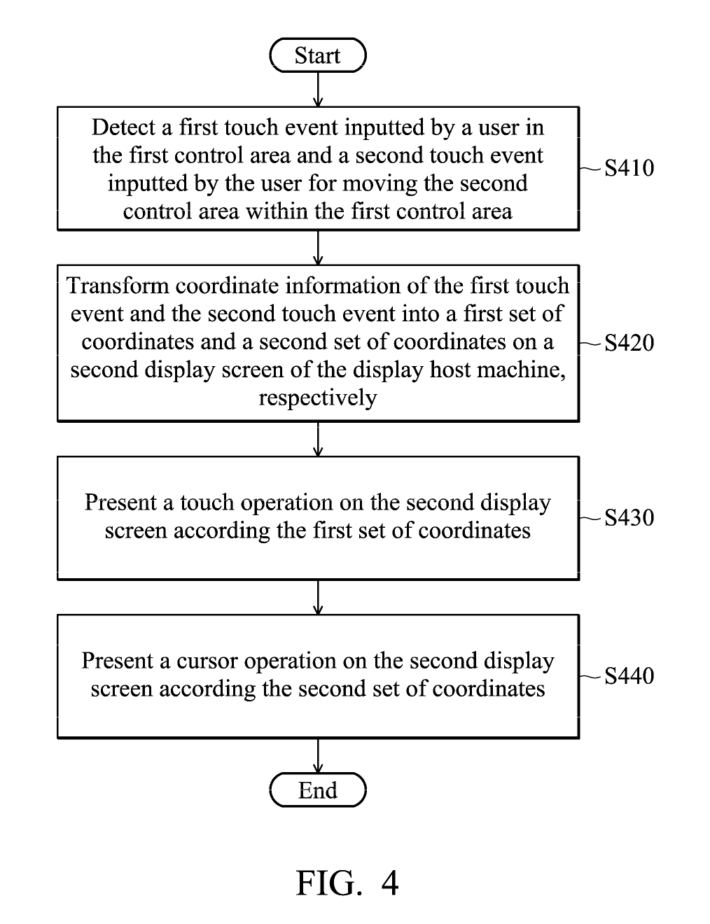

FIG. 4 is a flow chart illustrating the MMI operation method according to an exemplary embodiment. The MMI operation method is applied to a mobile communication device for remotely controlling a display host machine using wireless technology. Particularly, the display screen of the mobile communication device includes a first control area (i.e., the control area 101) and a second control area (i.e., the control area 102) within the first control area. To begin, the mobile communication device detects a first touch event inputted by a user in the first control area and a second touch event inputted by the user for moving the second control area within the first control area (step S410). Next, the mobile communication device transforms the coordinate information of the first touch event and the second touch event into a first set of coordinates and a second set of coordinates on a second display screen of the display host machine, respectively (step S420). Subsequently, the mobile communication device presents a touch operation on the second display screen according the first set of coordinates (step S430), and presents a cursor operation on the second display screen according the second set of coordinates (step S440).

In one embodiment, step S430 may be performed according to the type of the first touch event, and step S440 may be performed according to the type of the second touch event. Specifically, the type of the first touch event may be a tap, a drag, a slide, a long-press, or a drag-after-long-press type of touch operation, and the type of the second touch event may be a click, a drag, a long-press, or a drag-after-long-press type of cursor operation.

Regarding the types of the first touch event, related operations are similar to general touch operations for smart phones. For example, if the type of the first touch event is a tap type, the touch operation may include the effect of a visual object being selected and/or an application corresponding to the visual object being executed. If the type of the first touch event is a slide type, the touch operation may include the effect of sweeping, page flipping, or a visual object being moved, etc. If the type of the first touch event is a long-press type, the touch operation may include the effect of a visual object hovering. If the type of the first touch event is a drag-after-long-press type, the touch operation may include the effect of a visual object being moved. Regarding detailed description of the touch detection and type determination in the touch operation, reference may be made to any one of the well known technical schemes used for smart phones and panel PCs, and thus it is omitted herein for brevity.

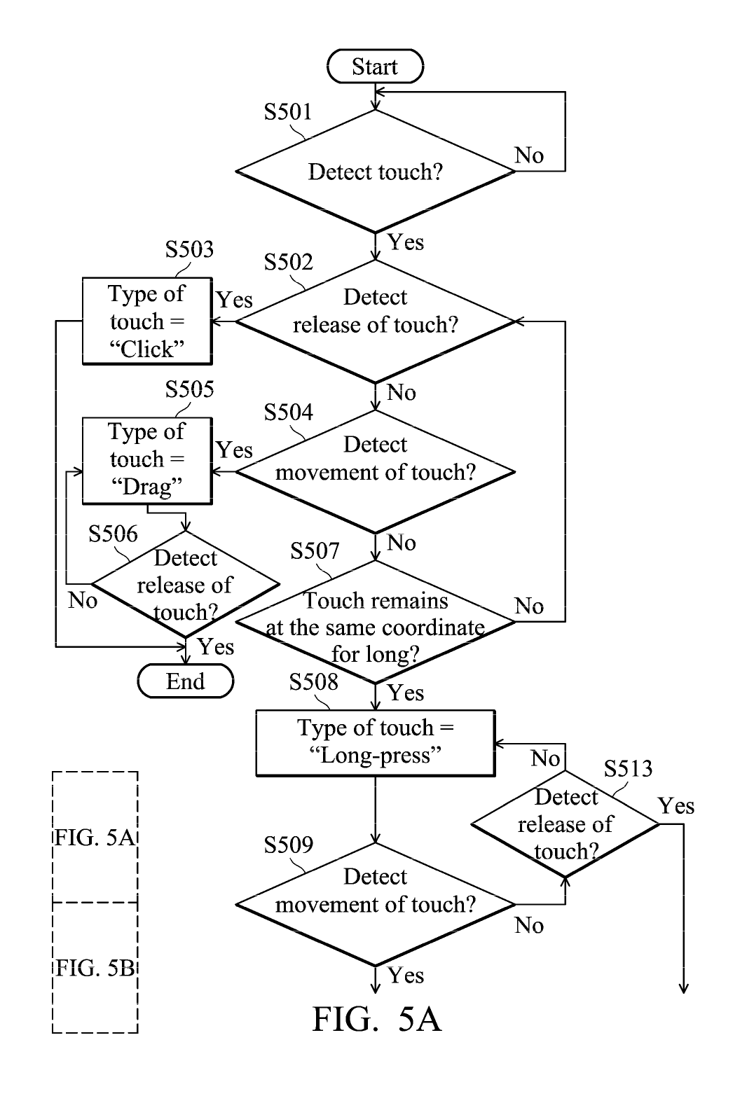

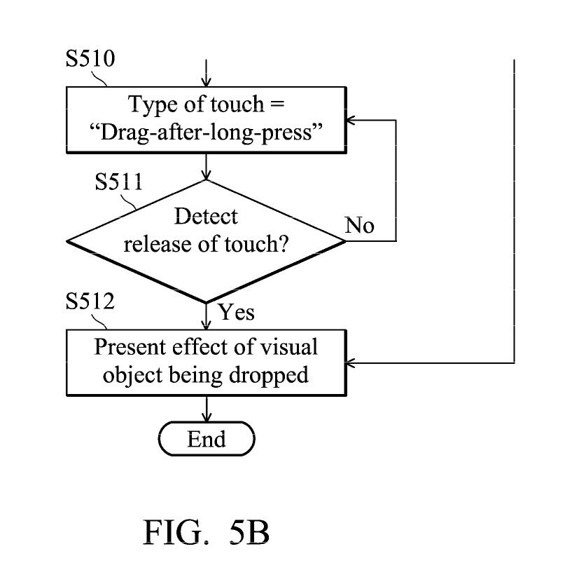

FIGS. 5A and 5B show a flow chart illustrating the type determination of the second touch event according to an exemplary embodiment. To begin, it is detected whether a user touches the local display screen 100 (step S501), i.e., it is determined whether a touch event is detected on the local display screen 100, and if not, detection continues. Otherwise, if the user touches on the local display screen 100, then it is detected whether the user releases the touch on the local display screen 100 (step S502), i.e., it is determined whether the touch remains detected at the same set of coordinates on the local display screen 100 for less than a predetermined period of time, and if so, the type of the touch event is determined to be the click type of cursor operation (step S503). For the click type, the cursor operation may include the effect of cursor-down and cursor-up, which is similar to the effect of a single click of the mouse button in the general MMI operations of a computer.

Subsequent to step S502, if not, it is detected whether the user moves the touch on the local display screen 100 (step S504). If the user moves the touch on the local display screen 100, i.e., the touch event remains detected at the same set of coordinates on the local display screen 100 for less than a predetermined period of time, the type of the touch event is determined to be the drag type of cursor operation (step S505). For the drag type, the cursor operation may include the effect of a visual object on screen being moved, which is similar to the effect of moving the mouse while pressing the mouse button in the general MMI operations of a computer.

After that, it is detected whether the user releases the touch on the local display screen 100 (step S506), and if so, the type determination ends. Otherwise, if the user does not release the touch on the local display screen 100, the type determination proceeds to step S505 to continuously update the movement of the drag type touch event.

Subsequent to step S504, if not, it is determined whether the touch event remains detected at the same set of coordinates on the local display screen 100 for more than a predetermined period of time (step S507). If the touch event remains detected at the same set of coordinates for more than the predetermined period of time, the type of the touch event is determined to be the long-press type of cursor operation (step S508). Otherwise, if the touch event does not remain detected at the same set of coordinates for more than the predetermined period of time, the type determination proceeds to step S502. For the long-press type, the cursor operation may include a hovering effect of a visual object on the local display screen 100, which is similar to the effect of long pressing a visual object on screen to make it slightly lifted or popped up in the general MMI operations of a smart phone.

Subsequent to step S508, it is detected whether the user moves the touch on the local display screen 100 (step S509). If the user moves the touch on the local display screen 100, i.e., the touch event remains detected at the same set of coordinates on the local display screen 100 for more than a predetermined period of time and the detected coordinates continue to change, the type of the touch event is determined to be the drag-after-long-press type of cursor operation (step S510). For the drag-after-long-press type, the cursor operation may include an effect of moving a visual object on the local display screen 100 along the changes of the detected coordinates, which is similar to the effect of long pressing a visual object on screen to make it slightly lifted or popped up and then moving the visual object on screen to wherever the touch is detected in the general MMI operations of a smart phone.

Finally, it is detected whether the user releases the touch on the local display screen 100 (step S511), and if so, the cursor operation presents an effect of a visual object on the local display screen 100 being dropped (step S512). Subsequent to step S509, if not, it is detected whether the user releases the touch on the local display screen 100 (step S513). If the user releases the touch on the local display screen 100, the type determination proceeds to step S512 for the cursor operation to present the effect of a visual object on the local display screen 100 being dropped.

The dropping effect in step S512 is similar to the effect of long pressing a visual object on screen to make it slightly lifted or popped up and then dropped down, or long pressing a visual object on screen to make it slightly lifted or popped up and then moving the visual object to wherever the touch is detected before dropping the visual object, in the general MMI operations of a smart phone. Depending on the application or service in use, the visual object on screen is dropped at the set of coordinates where the release of the touch is detected, or is dropped from the release coordinates to a predetermined set of coordinates along a particular track. For example, if the application in use is a user interface of a platform for smart phones and the long-press touch event is associated with the arrangement of desktop objects on the user interface, the hovering object corresponding to the long-press touch event may be dropped at the set of coordinates where the release of the long-press touch event is detected. Alternatively, if the hovering object corresponding to the long-press touch event is dropped in an invalid area, a gliding effect may be presented to drop the hovering object from the release coordinates to a predetermined set of coordinates in a valid area along a particular track. If the application in use is a mobile game and the drag-after-long-press touch event is associated with the strike of a slingshot, an effect of the pocket bouncing back to its loose position may be presented when the drag-after-long-press touch event is released.

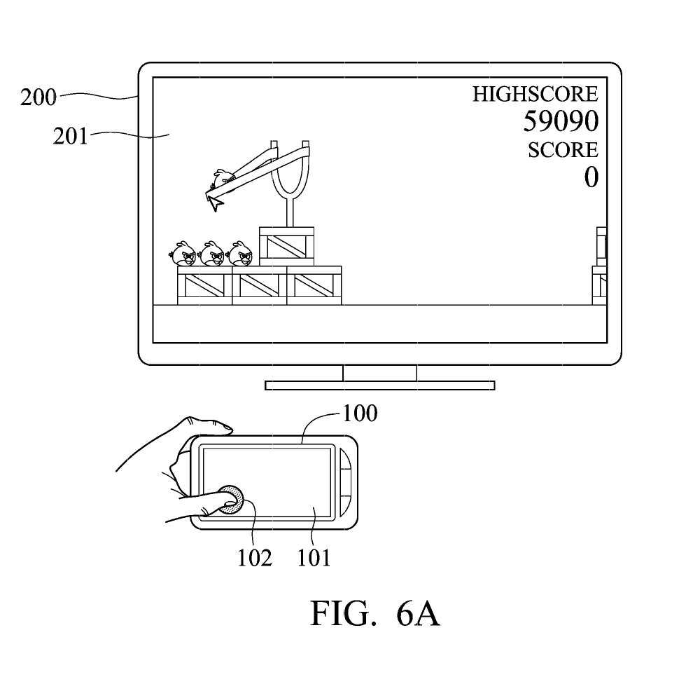

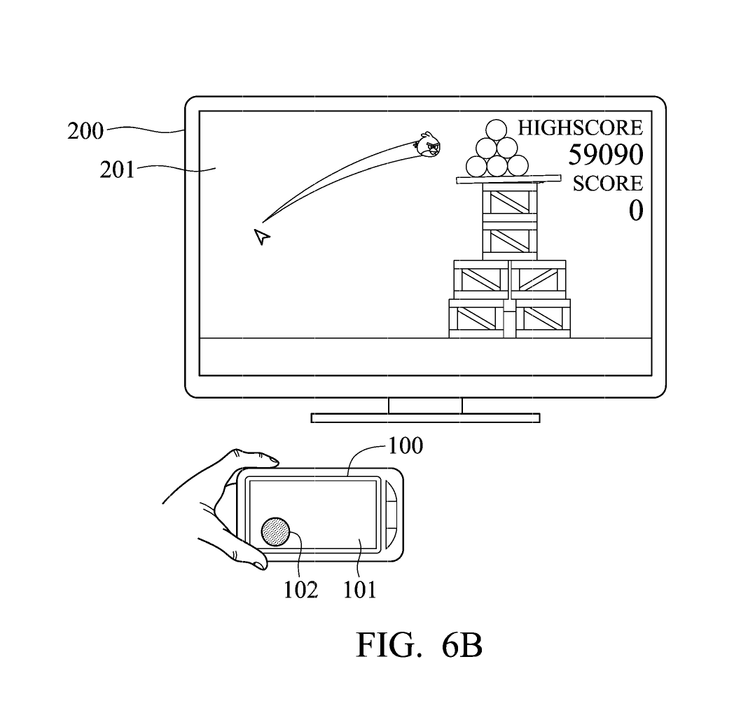

FIGS. 6A and 6B show schematic diagrams for the controls of a mobile game via a movable control area according to an exemplary embodiment. In this embodiment, the application in use is a mobile game, and the scene of the mobile game is displayed in the display area 201 of the remote display screen 200. In the local display screen 100, the control area 102 is movable and displayed within the control area 101 which is stationary, and the user may touch to move the control area 102 within the control area 101. The set of coordinates in the control area 102 is mapped or transformed into a set of coordinates in the display area 201 of the remote display screen 200, where a cursor is shown for the user to remotely control the mobile game displayed on the remote display screen 200. Specifically, the user may long press and drag the control area 102, to cause the slingshot to prepare for a strike, as shown in FIG. 6A. Later, the user may release the touch on the control area 102, to cause the pocket of the slingshot to bounce back to its loose position after shooting the projectile, as shown in FIG. 6B.

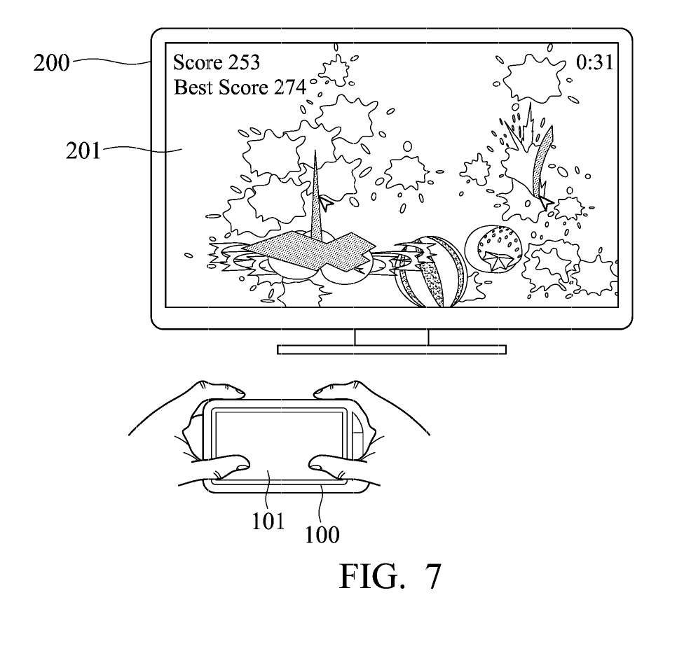

FIG. 7 is a schematic diagram for the controls of a mobile game via a stationary control area according to an exemplary embodiment. As shown in FIG. 7, the application in use is a mobile game, and the scene of the mobile game is displayed in the display area 201 of the remote display screen 200. The user may use both of his/her hands to touch the stationary control area 101 of the local display screen 100. When the figures of various fruits appear in the scene of the mobile game, the user may use his/her fingers to slide on the stationary control area 101, to cause the slicing of the fruits.

While the disclosure has been described by way of example and in terms of preferred embodiment, it is to be understood that the disclosure is not limited thereto. Those who are skilled in this technology can still make various alterations and modifications without departing from the scope and spirit of this disclosure. Therefore, the scope of the disclosure shall be defined and protected by the following claims and their equivalents.

Use of ordinal terms such as “first” and “second” in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

What is claimed is:

1. A mobile communication device, comprising:
a wireless communication module, configured to perform wireless transmission and reception to and from a display host machine;
a local display device, equipped with a first display screen comprising a first control area and a second control area within the first control area; and
a processing module, configured to detect a first touch event inputted by a user in the first control area and a second touch event inputted by the user for moving the second control area within the first control area, transform coordinate information of the first touch event and the second touch event into a first set of coordinates and a second set of coordinates on a second display screen of the display host machine, respectively, present a touch operation on the second display screen via the wireless communication module according the first set of coordinates, and present a cursor operation on the second display screen via the wireless communication module according the second set of coordinates.

2. The mobile communication device of claim 1, wherein the presentation of the touch operation on the second display screen is performed according to a type of the first touch event, and the presentation of the cursor operation on the second display screen is performed according to a type of the second touch event.

3. The mobile communication device of claim 2, wherein the type of the second touch event may be a click, a drag, a long-press, or a drag-after-long-press type.

4. The mobile communication device of claim 3, wherein the processing module is further configured to determine whether the second touch event remains detected on the same set of coordinates more than a predetermined period of time, if so, determine the type of the second touch event to be the long-press type, and if not, determine the type of the second touch event to be the click type.

5. The mobile communication device of claim 4, wherein the cursor operation comprises effects of cursor-down and cursor-up, in response to the type of the second touch event being the click type.

6. The mobile communication device of claim 4, wherein the cursor operation comprises a hovering effect of a visual object on the first display screen, in response to the type of the second touch event being the long-press type.

7. The mobile communication device of claim 3, wherein the processing module is further configured to determine whether the second touch event remains detected on the same set of coordinates for less than a predetermined period of time and the detected coordinates continue to change, and if so, determines the type of the second touch event to be the drag type.

8. The mobile communication device of claim 7, wherein the cursor operation comprises an effect of moving, in response to the type of the second touch event being the drag type.

9. The mobile communication device of claim 3, wherein the processing module is further configured to determine whether the second touch event remains detected on the same set of coordinates for more than a predetermined period of time and then the detected coordinates change, and if so, determines the type of the second touch event to be the drag-after-long-press type.

10. The mobile communication device of claim 9, wherein the cursor operation comprises an effect of moving a visual object along the changes of the detected coordinates, in response to the type of the second touch event being the drag-after-long-press type.

11. A Machine-Machine Interface (MMI) operation method for a mobile communication device to remotely control a display host machine which is equipped with a first display screen comprising a first control area and a second control area within the first control area, the MMI operation method comprising:
detecting a first touch event inputted by a user in the first control area and a second touch event inputted by the user for moving the second control area within the first control area;
transforming coordinate information of the first touch event and the second touch event into a first set of coordinates and a second set of coordinates on a second display screen of the display host machine, respectively;
presenting a touch operation on the second display screen according the first set of coordinates; and
presenting a cursor operation on the second display screen according the second set of coordinates.

12. The MMI operation method of claim 11, wherein the presentation of the touch operation on the second display screen is performed according to a type of the first touch event, and the presentation of the cursor operation on the second display screen is performed according to a type of the second touch event.

13. The MMI operation method of claim 12, wherein the type of the second touch event may be a click, a drag, a long-press, or a drag-after-long-press type.

14. The MMI operation method of claim 13, further comprising:
determining whether the second touch event remains detected on the same set of coordinates over a predetermined period of time;
if so, determining the type of the second touch event to be the long-press type; and
if not, determining the type of the second touch event to be the click type.

15. The MMI operation method of claim 14, wherein the cursor operation comprises effects of cursor-down and cursor-up, in response to the type of the second touch event being the click type.

16. The MMI operation method of claim 14, wherein the cursor operation comprises an effect of hovering, in response to the type of the second touch event being the long-press type.

17. The MMI operation method of claim 13, further comprising:
determining whether the second touch event remains detected on the same set of coordinates for less than a predetermined period of time and the detected coordinates continues to change; and
if so, determining the type of the second touch event to be the drag type.

18. The MMI operation method of claim 17, wherein the cursor operation comprises an effect of moving, in response to the type of the second touch event being the drag type.

19. The MMI operation method of claim 13, further comprising:
determining whether the second touch event remains detected on the same set of coordinates over a predetermined period of time and then the detected coordinates changes; and
if so, determining the type of the second touch event to be the drag-after-long-press type.

20. The MMI operation method of claim 19, wherein the cursor operation comprises an effect of moving a visual object along the changes of the detected coordinates, in response to the type of the second touch event being the drag-after-long-press type.
